(19) United States
(12) Patent Application Publication
(10) Pub. No.: US 2026/0103038 A1
(43) Pub. Date: Apr. 16, 2026

(54) BUSHING DESIGN TO ENABLE DIFFERENT HARDPOINTS

(71) Applicant: Ford Global Technologies, LLC, Dearborn, MI (US)

(72) Inventors: Patrick Jones, Laguna Niguel, CA (US); Andrew Reimer, Newport Beach, CA (US)

(21) Appl. No.: 18/914,548

(22) Filed: Oct. 14, 2024

(51) Int. Cl. B60G 7/02

(52) U.S. Cl. CPC B60G 7/02; B60G 2204/143; B60G 2204/4104

(57) ABSTRACT

The bushing may include a first end having a first coupling interface configured to operably couple to a first coupling point or a second coupling point, a second end having a second coupling interface configured to operably couple to the second coupling point or the first coupling point, an inner metal portion, an outer metal portion, and an elastic portion. A hardpoint may be defined between the first end and the second end along the inner metal portion at a first hardpoint location and a second hardpoint location. The second hardpoint location may be shifted along a common axis relative to the first hardpoint location.

### TECHNICAL FIELD

Example embodiments generally relate to movable assembly joints, more particularly, relate to a bushing that enables different kinematic hardpoint locations.

### BACKGROUND

Hardpoints are important locations on a vehicle, as they combine to define the motion and loading of chassis subsystems (suspension, steering, brakes, wheels, and tires) relative to the vehicle body structure. Typically, hardpoints are located at fixed positions where the suspension system or other vehicle assemblies (i.e. power unit assembly, etc.) connect to the chassis or frame of the vehicle. Hardpoints help define crucial kinematic and preference parameters such as ride height, roll center height, anti-geometry, bump steer, toe change under braking, and thus it is important to specify the location of hardpoints to ensure subsystem parameters support the attribute goals of the vehicle.

As the hardpoints are typically located at the connection between vehicle assemblies and the chassis, the hardpoints are often disposed at a bushing. To currently adjust the hardpoints to the desired vehicle characteristics, numerous different types of body-side bushing interfaces are needed, as a single bushing can only be connected to the chassis with its hardpoint in one intended location. Therefore, a bushing that changes hardpoint location based on the bushing orientation when installed to provide increased vehicle customization without the need for numerous parts may be desired.

### BRIEF SUMMARY OF SOME EXAMPLES

In accordance with an example embodiment, a bushing of a coupling assembly may be provided. The bushing may include a first end having a first coupling interface configured to operably couple to a first coupling point or a second coupling point, a second end having a second coupling interface configured to operably couple to the second coupling point or the first coupling point, an inner metal portion disposed along a first centerline axis of the bushing, an outer metal portion disposed radially outward from the inner metal portion, and an elastic portion disposed between the inner metal portion and the outer metal portion. A hardpoint may be defined between the first end and the second end along the inner metal portion at a first hardpoint location responsive to the first coupling interface operably coupling to the first coupling point and the second coupling interface operably coupling to the second coupling point, and a second hardpoint location responsive to the first coupling interface operably coupling to the second coupling point and the second coupling interface operably coupling to the first coupling point. The second hardpoint location may be shifted along a common axis relative to the first hardpoint location.

In another example embodiment, a suspension assembly of a vehicle may be provided. The suspension assembly may include a control arm to operably couple a wheel end assembly to a chassis of the vehicle, and a bushing to operably couple the control arm to the chassis. The bushing may further include a first end having a first coupling interface configured to operably couple to a first coupling point or a second coupling point of a chassis of the vehicle, a second end having a second coupling interface configured to operably couple to the second coupling point or the first coupling point of the chassis, an inner metal portion disposed along a first centerline axis of the bushing, an outer metal portion disposed radially outward from the inner metal portion, and an elastic portion disposed between the inner metal portion and the outer metal portion. A hardpoint may be defined between the first end and the second end along the inner metal portion at a first hardpoint location responsive to the first coupling interface operably coupling to the first coupling point and the second coupling interface operably coupling to the second coupling point, and a second hardpoint location responsive to the first coupling interface operably coupling to the second coupling point and the second coupling interface operably coupling to the first coupling point. The second hardpoint location may be shifted along a common axis relative to the first hardpoint location.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a suspension assembly for a vehicle in accordance with an example embodiment;

FIG. 2, illustrates a perspective view of a through-bushing of a suspension assembly in accordance with an example embodiment;

FIG. 3, defined by FIG. 3A and FIG. 3B, depicts a cross-section of a through-bushing of a suspension assembly in accordance with an example embodiment;

FIG. 4, illustrates a perspective view of a bar pin bushing of a suspension assembly in accordance with an example embodiment;

FIG. 5 depicts a cross-section of a bar pin bushing of a suspension assembly in accordance with an example embodiment;

FIG. 6, defined by FIG. 6A and FIG. 6B, illustrates a perspective view of an inclined bar pin bushing of a suspension assembly in accordance with an example embodiment; and FIG. 7, defined by FIG. 7A and FIG. 7B, depicts a cross-section of an inclined bar pin bushing of a suspension assembly in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about,” “approximately” and “substantially,” when used to refer to variability of parameters, should be understood to be definite approximations that account for variations in measurements that cannot be, or as one of skill in the art would appreciate, normally are not, measured precisely. Thus, for example, a parameter that is “about,” “approximately” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide a bushing for a suspension assembly of a vehicle with a variable hardpoint location. As a result, the bushing may provide increased vehicle customization without the need for numerous parts. Instead, due to the architecture of the bushing itself, the hardpoint location may be changed by simply changing the orientation of the bushing within the vehicle.

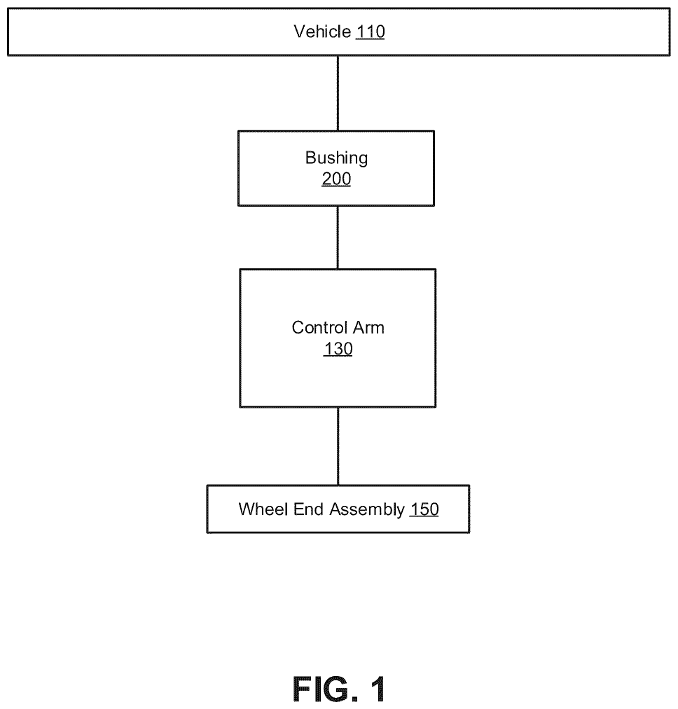

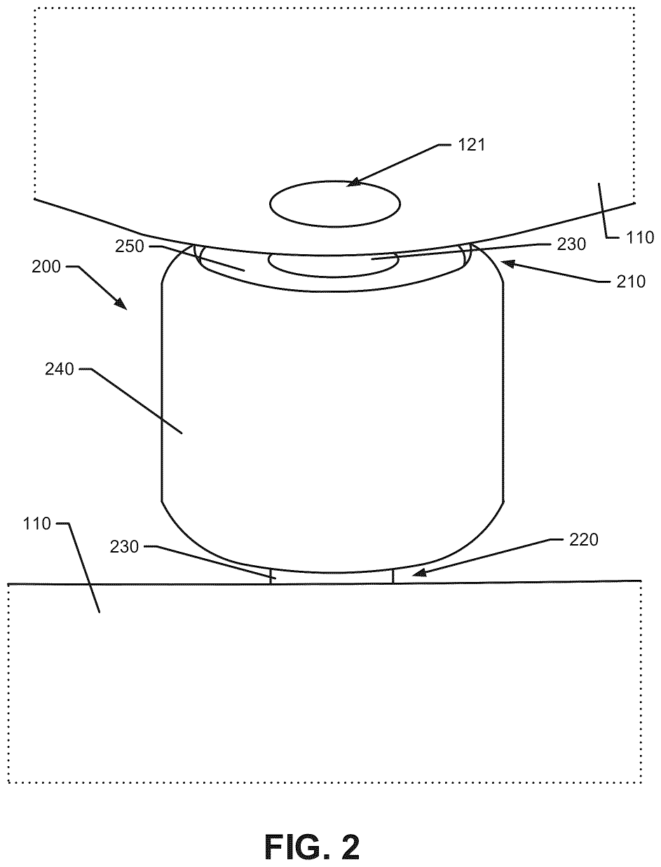

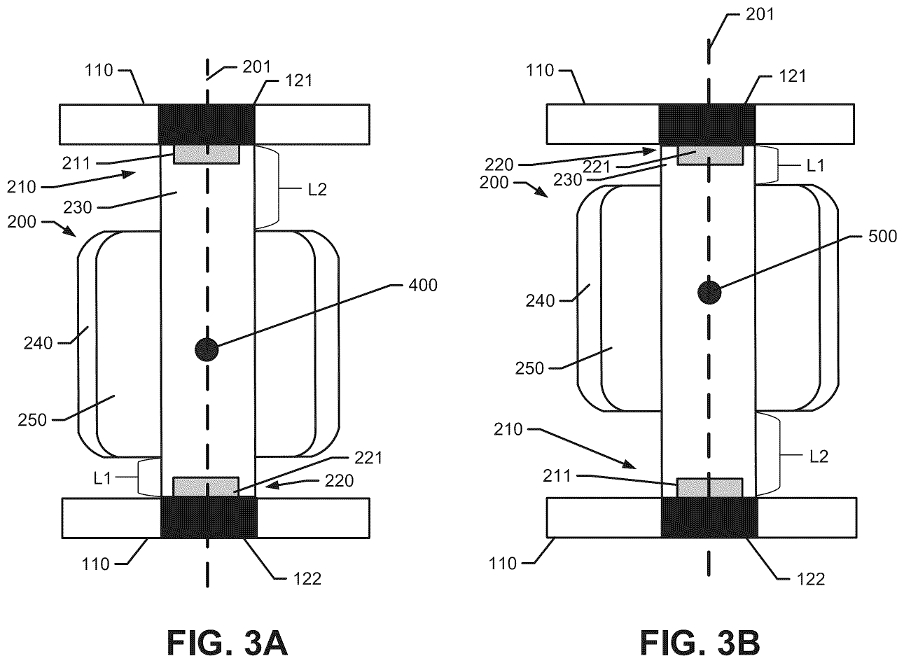

FIG. 1 illustrates a block diagram of a suspension assembly for a vehicle 110 in accordance with an example embodiment. FIG. 2 and FIG. 3 illustrate a perspective view and a cross-section respectively of a through-bushing within the vehicle environment. In some cases, the vehicle 110 may include or may be represented by a chassis. In an example embodiment, the chassis may be a frame or body of the vehicle 110. In some cases, the chassis or frame may support and/or may form the foundation structure of the vehicle 110. In some cases, the chassis and/or frame may be formed of one or more casted or welded metal subframes or may be a unibody construction, and a suspension element may be operably coupled to the chassis, frame, or directly to a body structure of the vehicle 110 to help operably couple a wheel end assembly 150 to the chassis or frame. A wheel end assembly 150 may include but is not limited to a steering knuckle, a wheel, a tire, or brakes.

In some cases, the suspension element may be a variety of different components within the suspension assembly of the vehicle 110. In an example embodiment, the suspension element may be a control arm 130. The control arm 130 may help guide and increase control over the wheel end assembly 150. The control arm 130 may help operably couple the vehicle 110 to the wheel end assembly 150. The vehicle 110 may include multiple instances of the control arm 130. For example, the control arm 130 may include an upper and/or lower control arm for the front and/or rear of the vehicle 110. In some cases, the control arm 130 may operably couple a steering knuckle of the wheel end assembly 150 to the vehicle 110. In an example embodiment, the control arm 130 may be integrated within the suspension assembly.

The suspension assembly may include other suspension components. For example, the suspension assembly may include a damper or other suspension elements. The suspension assembly may include multiple dampers depending on the vehicle 110. The damper may function to absorb compression and rebound loading along a centerline axis of the suspension damper. In this regard, the damper may significantly limit oscillations and vibrations of the vehicle 110 by dampening the articulation motion of the wheel end assembly 150 so that the articulation of the wheel end assembly 150 is not directly transferred to the vehicle 110 of the vehicle 110.

In an example embodiment, the control arm 130 may be operably coupled to the vehicle 110 via a bushing 200. The bushing 200 may operably couple to a variety of different locations of the vehicle 110. The bushing 200 may not be limited to operably coupling the control arm 130 to the vehicle 110 or other vehicle components. In some cases, the bushing 200 may operably couple other components of the suspension assembly, the wheel end assembly 150, and/or other vehicle assemblies to the vehicle 110 or to one another. The bushing 200 may be any of a number of types, including but not limited to a through-bushing or bar pin bushing. In an example embodiment, the bushing 200 may be a sleeve-type bushing. The bushing 200 may be disposed at end of or integrated with the end of the control arm 130 to assist in operably coupling the control arm 130 and the vehicle 110. The bushing 200 may allow for pivoting or minor movement of the control arm 130 relative the vehicle 110 while operably coupled. The pivoting and minor movement may increase durability of the vehicle component and the suspension assembly.

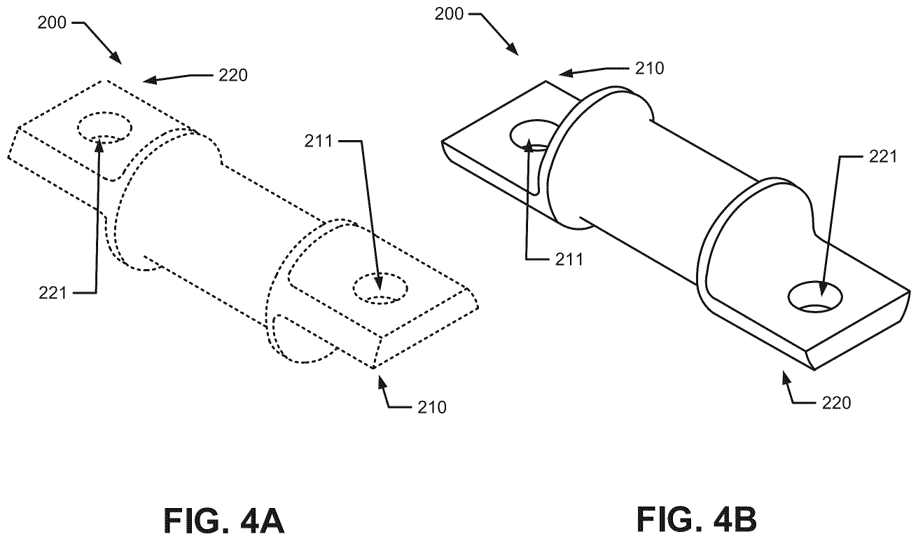

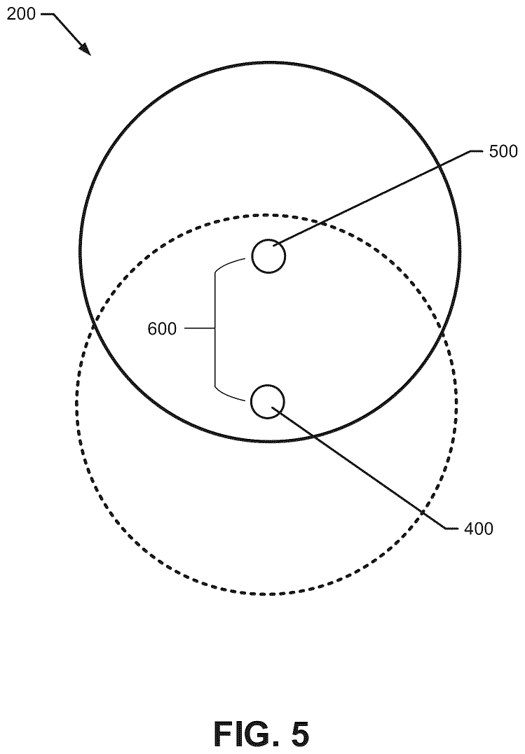

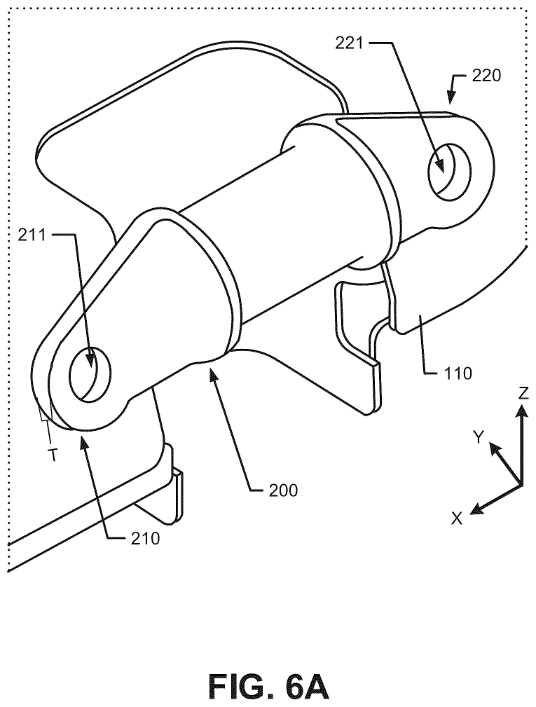

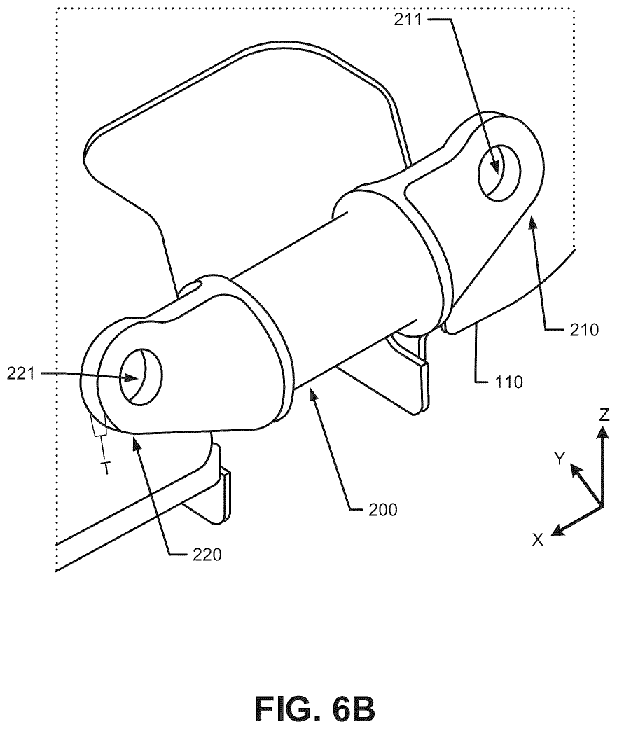

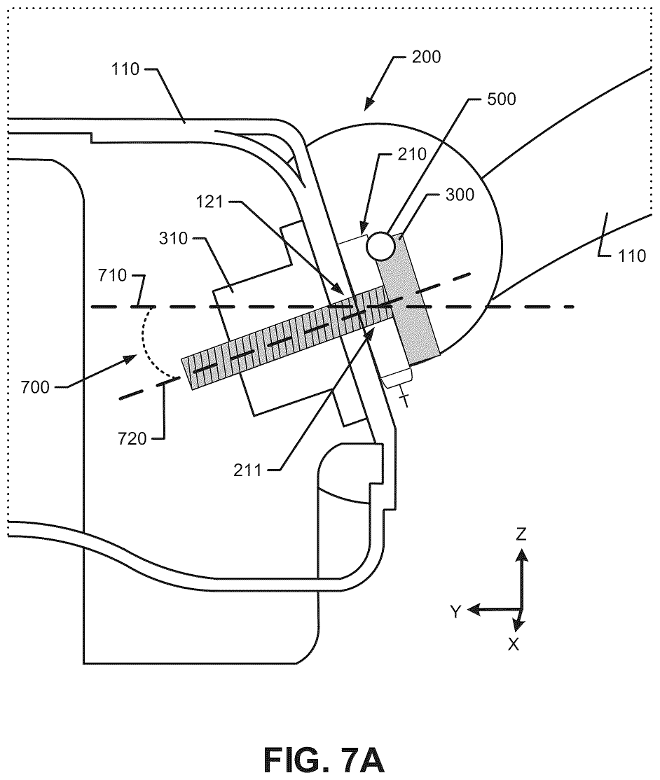

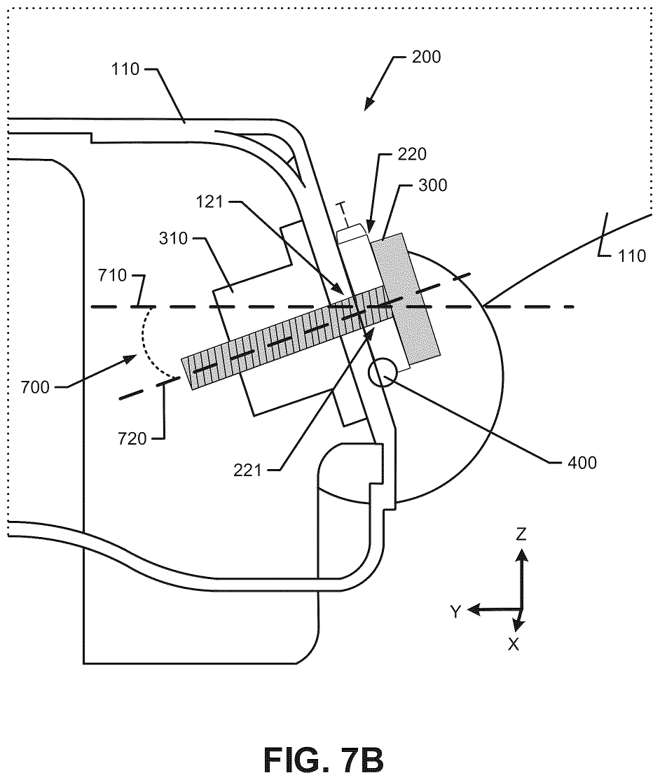

FIGS. 2-7 depict perspective views and cross-sections of various bushing types disposed with and without the surrounding vehicle environment. Accordingly, FIG. 2 and FIG. 3 illustrate a perspective view and cross-sections respectively of a through-bushing within the vehicle environment. FIG. 4 and FIG. 5 depict perspective views and a cross-sections, respectively, of a bar pin bushing. FIG. 6 and FIG. 7 illustrate a perspective views and a cross-sections, respectively, of an inclined bar pin bushing within the vehicle environment.

In some cases, the bushing 200 may include a first end 210 and a second end 220. The first end 210 may include a first coupling interface 211, and the second end 220 may include a second coupling interface 221. The first coupling interface 211 and the second coupling interface 221 may operably couple to the vehicle 110 at a first coupling point 121 or a second coupling point 122. In an example embodiment, the first coupling point 121 and the second coupling point 122 may be disposed directly on the vehicle 110. For example, the first coupling point 121 and/or the second coupling point 122 may be receiving orifice or aperture disposed on and integrated within the vehicle 110 or a bracket or similar component attached to the vehicle 110.

In some cases, the first coupling interface 211 and the second coupling interface 221 may operably couple to the first coupling point 121 and the second coupling point 122 via a fastener 300 (see FIG. 7). In an example embodiment, the fastener 300 may be a rod, bolt, pin, or screw. The fastener 300 may further include a cap or nut 310 to help secure the bushing 200 to the vehicle 110. For example, as seen in the cross-section of the inclined bar pin bushing and the surrounding vehicle environment in FIG. 7, the fastener 300 is a threaded bolt secured via a nut 310 through the first coupling point 121 of the vehicle 110 and the first coupling interface 211 of the bushing 200.

In some cases, the bushing 200 may include multiple, separate portions formed of different materials. For example, the bushing 200 may include an inner metal portion 230, an outer metal portion 240, and an elastic portion 250. In an example embodiment, the inner metal portion 230 may be disposed and centered along a first centerline axis 201 of the bushing 200. The outer metal portion 240 may be disposed radially outward from the inner metal portion 230. The outer metal portion 240 may surround a majority of the inner metal portion 230 so that the majority of the inner metal portion 230 may not be visible from an exterior of the vehicle or while the bushing 200 is in use. The inner metal portion 230 and the outer metal portion 240 may be made of a variety of metals, including but not limited to steel and aluminum. In some cases, the inner metal portion 230 and the outer metal portion 240 may also be made of non-metallic materials, as long as the non-metallic materials do not alter functionality of the bushing 200.

In an example embodiment, the elastic portion 250 may be disposed between the inner metal portion 230 and outer metal portion 240. The elastic portion 250 may be formed of various elastic materials, including but not limited to rubber, elastic polymers, plastics, and silicon-based materials. In some cases, the elastic portion 250 may completely surround the inner metal portion 230.

In some cases, the inner metal portion 230 may be hollow or partially hollow and may receive the fastener 300. The inner metal portion 230 may be threaded and receive a threaded bolt to secure the bushing 200 to the vehicle 110. For example, if the bushing 200 is a through-bushing as shown in FIG. 2 and FIG. 3, a threaded bolt (not shown) may pass through the vehicle 110 at the first coupling point 121 and engage threads of the inner metal portion 230 at the first coupling interface 211 of the first end 210 of the bushing 200. A similar type of operable coupling may occur at the second coupling point 122 with the second coupling interface 221 on the opposite side of the bushing 200. In an example embodiment, the inner metal portion 230 may extend past either or both of the outer metal portion 240 and the elastic portion 250 by lengths L1 and L2. The extension of the inner metal portion 230 past the outer metal portion 240 and the elastic portion 250 may not be uniform at the first end 210 and the second end 220. For example, the length of the extension at the first end 210, may be the same or larger than the length of the extension at the second end 220. The longer length may be length L2 and the shorter length may be length L1. Thus, for example, the inner metal portion 230 may extend past the outer metal portion 240 and the elastic portion 250, by a larger amount at the second end 220 than the first end 210.

In an example embodiment, the bushing 200 may have a hardpoint. The hardpoint may be a location at positions where the suspension system or other vehicle assemblies (i.e. power unit assembly, etc.) connect to the chassis or frame of the vehicle. The hardpoint, and particularly its location relative to the first and second ends 210 and 220, may help determine vehicle characteristics/parameters, such as but not limited to ride height, roll center height, and turning characteristics. In some cases, the bushing 200 of an example embodiment may be unique in that, whereas the hardpoint is typically a fixed design attribute, it may be possible to move the location of the hardpoint based on changing the orientation of the bushing 200 to thereby also alter the vehicle characteristics/parameters that are adjusted by hardpoint location. The hardpoint of the bushing 200 may be disposed at a location along the inner metal portion 230 between the first end 210 and the second end 220 of the bushing 200. As hardpoints are locations designed to carry loads, the hardpoint may be disposed on the inner metal portion 230 to increase durability of the bushing 200 during operation of the vehicle 110 and movement of the suspension assembly.

In some cases, as noted above, depending on an orientation of the bushing 200, the location of the hardpoint may vary. For example, responsive to the first coupling interface 211 operably coupling to the first coupling point 121 and the second coupling interface 221 operably coupling to the second coupling point 122, the hardpoint may be disposed at a first hardpoint location 400, as shown in FIG. 3A. However, if you flip the bushing 200 in terms of its orientation, i.e., responsive to the first coupling interface 211 operably coupling to the second coupling point 122 and the second coupling interface 221 operably coupling to the first coupling point 121, the hardpoint may be disposed at a second hardpoint location 500 as shown in FIG. 3B. In an example embodiment, the first hardpoint location 400 may be shifted from the second hardpoint location 500 along a common axis (e.g., the first centerline axis 201 of FIG. 3). The common axis may be an axis of the vehicle 110, such as an X-axis, a Y-axis, or a Z-axis. The X-axis may extend along a longitudinal length (i.e. front to back) of the vehicle 110, the Y-axis may extend along a lateral length (i.e. left to right) of the vehicle 110, and the Z-axis may extend along a vertical length (i.e. bottom to top, or close to far from driving surface) of the vehicle 110. Thus, in the example of FIGS. 2 and 3, in which the first centerline axis 201 extends in the vertical direction, the second hardpoint location 500 may be shifted along the Z-axis relative to the first hardpoint location 400 by flipping the ends of the bushing 200 around prior to installation.

A difference in the first hardpoint location 400 and the second hardpoint location 500 along the common axis may define an offset 600. The offset 600 may determine a change in vehicle parameters. For example, the vehicle 110 may have a first ride height responsive to the hardpoint being disposed at the first hardpoint location 400 and a second ride height responsive to the hardpoint being disposed the second hardpoint location 500. The first ride height at the first hardpoint location 400 may be a higher ride height than the second ride height at the second hardpoint location 500 due to an engagement orientation of the control arm 130 relative to the vehicle 110. In some cases, the roll center height may vary responsive to the offset 600.

In an example embodiment, the difference in location between the first hardpoint location 400 and the second hardpoint location 500 may only be along the common axis. For example, upon shifting to the second hardpoint location 500 relative the first hardpoint location 400, an X-coordinate and a Y-coordinate of the first hardpoint location 400 and the second hardpoint location 500 may be the same and only a Z-coordinate of the first hardpoint location 400 and the second hardpoint location 500 may change. The change in the Z coordinate may then be determined as the offset 600 in accordance with an example embodiment.

In some cases, such as in the example above, the bushing 200 may be in a first state responsive to the first coupling interface 211 operably coupling to the first coupling point 121 and second coupling interface 221 operably coupling to the second coupling point 122, and the bushing 200 may be in a second state responsive to the first coupling interface 211 operably coupling to the second coupling point 122 and the second coupling interface 221 operably coupling to the first coupling point 121. Thus, the bushing 200 may have the hardpoint disposed at the first hardpoint location 400 in the first state and disposed at the second hardpoint location 500 in the second state. In an example embodiment, the bushing may be rotated an amount of degrees between the first state and the second state.

For example, FIG. 4 (including FIG. 4A and FIG. 4B) and FIG. 5 may depict the offset 600 in accordance with an example embodiment. FIG. 4A depicts the bushing 200 in a first orientation (illustrated via dotted lines) and FIG. 4B depicts the bushing 200 in a second orientation (illustrated via the solid lines). FIG. 5 illustrates a cross-section view of the bushing 200 of FIG. 4 in both the first and second orientation. In an example embodiment, the change in orientation between FIG. 4A and FIG. 4B may result in the offset 600 between the first hardpoint location 400 and the second hardpoint location 500.

The offset 600 changing based only on a rotation of the bushing 200 may enable the location of the hardpoint to change between different types of vehicles without a variety of different types of bushings. Based on an installation orientation of the bushing 200, the location of the hardpoint may be shifted, and thus easily adjust vehicle parameters. In some cases, the bushing 200 may have indications, coloring, patterns, or other markings to help for quick recognition of installation direction of the bushing 200 for the desired hardpoint location or desired vehicle parameter.

In some cases, depending on locations of the first coupling point 121 and the second coupling point 122, as well as depending on the design of the bushing 200, the second hardpoint location 500 may be shifted along a common axis, even responsive to the first coupling point 121 and the second coupling point 122 being disposed at different locations along the X-axis, the Y-axis, and the Z-axis. For example, as seen in FIG. 6 and FIG. 7, the first coupling point 121 and the second coupling point 122 have different X, Y, and Z-coordinates from one another, and the second hardpoint location 500 may still be shifted only along the common axis (Z axis). In other words, even though the bushing 200 may be adjusted along any or all of X, Y and Z axes, the hardpoint location may still change only along one axis.

In an example embodiment, the offset 600 may be variable based on bushing parameters. In some cases, the bushing parameter may be a jog 700 of the bushing 200. The jog of the bushing 200 may be defined as an distance between a second centerline axis 710 of the bushing 200 and a third centerline axis of the fastener axis 720 of the fastener 300 that operably couples the bushing 200 to the vehicle 110. The second centerline axis 710 of the bushing 200 may be substantially parallel with a vehicle's horizontal axis (i.e. the Y-axis as seen in FIG. 6 and FIG. 7). In an example embodiment, as the jog 700 decreases, the offset 600 may decrease. The decrease in the offset 600 responsive to the decrease in the jog 700 may thus decrease the difference between the first ride height and the second ride height.

In some cases, the bushing parameter may be a thickness T of the first coupling interface 211 and/or the second coupling interface 221. In an example embodiment, the thickness T may be constant throughout the first end 210 and/or the second end 220, including the first coupling interface 211 and the second coupling interface 221 respectively. In an example embodiment, if the thickness T of the first coupling interface 211 and/or the second coupling interface 221 decreases, the offset 600 may decrease. The decrease in the offset 600 responsive to the decrease in the thickness T may thus decrease the difference between the first ride height and the second ride height. In some cases, the thickness T, as well as the jog 700, may be used together to adjust the offset 600. For example, in an example embodiment such as in FIGS. 6 and 7, the combination of the thickness T and jog 700 help create the offset 600 for bushing 200 between orientations.

In some cases, the bushing parameter may include dimensions of the inner metal portion 230 of the bushing 200. The dimensions of the inner metal portion 230 of the bushing 200, include but are not limited to, the length L of the inner metal portion 230 along the first centerline axis 201 that extends beyond a corresponding end of the outer metal portion 240 and/or elastic portion 250, as well as a diameter of the of the inner metal portion 230, which is referred to as the extension, as noted above. The length L of the extension may be proportional with the offset 600. As the length L of the extension increases, the offset 600 may also increase. If the length L is different at the first end 210 and the second end 220 of the bushing 200, the offset 600 may increase.

In some cases, various bushing types and instances of the bushing 200 described in various embodiments may be integrate with one another within the vehicle 110. For example, the through-bushing shown in FIG. 2 and FIG. 3 and the inclined bar pin bushing shown in FIG. 6 and FIG. 7 may be integrated together at different locations along the vehicle 110. In an example embodiment, the common axis may not be the X-axis, the Y-axis, or the Z-axis, but may be another axis through the bushing 200 to shift the hardpoint location along. In some cases, the bushing 200 may have multiple instances of the common axis.

A bushing of a coupling assembly may therefore be provided. The bushing may include a first end having a first coupling interface configured to operably couple to a first coupling point or a second coupling point, a second end having a second coupling interface configured to operably couple to the second coupling point or the first coupling point, an inner metal portion disposed along a first centerline axis of the bushing, an outer metal portion disposed radially outward from the inner metal portion, and an elastic portion disposed between the inner metal portion and the outer metal portion. A hardpoint may be defined between the first end and the second end along the inner metal portion at a first hardpoint location responsive to the first coupling interface operably coupling to the first coupling point and the second coupling interface operably coupling to the second coupling point, and a second hardpoint location responsive to the first coupling interface operably coupling to the second coupling point and the second coupling interface operably coupling to the first coupling point. The second hardpoint location may be shifted along a common axis relative to the first hardpoint location.

The bushing of a coupling assembly of some embodiments may include additional features, modifications, augmentations and/or the like to achieve further objectives or enhance performance of the suspension system. The additional features, modifications, augmentations and/or the like may be added in any combination with each other. Below is a list of various additional features, modifications, and augmentations that can each be added individually or in any combination with each other. For example, the bushing may be a through-bushing or a bar pin bushing. In some cases, the vehicle may be at a first ride height responsive to the hardpoint being disposed at the first hardpoint location, and the vehicle may be at a second ride height responsive to the hardpoint being disposed at the second hardpoint location. In an example embodiment, the first coupling point and the second coupling point may be disposed at different locations along an X-axis, a Y-axis, and a Z-axis. In some cases, the bushing may be in a first state responsive to first coupling interface operably coupling to the first coupling point and the second coupling interface operably coupling to the second coupling point, the bushing may be in a second state responsive to the first coupling interface operably coupling to the second coupling point and the second coupling interface operably coupling to the first coupling point, and the bushing may be rotated an amount of degrees between the first state and the second state. In an example embodiment, a difference between the first hardpoint location and the second hardpoint location along the common axis between the first hardpoint location and the second hardpoint location may define an offset, and the offset may be variable based on bushing parameters. In some cases, the bushing parameters may include a jog of the bushing, and the jog of the bushing may be a distance offset between a second centerline axis of the bushing and a third centerline axis of a fastener configured to operably couple the bushing to the suspension assembly via the first coupling point or the second coupling point. In an example embodiment, the bushing parameters may include a thickness of the bushing at the first coupling interface and the second coupling interface. In some cases, the bushing parameters may include dimensions of the inner metal portion of the bushing. In an example embodiment, the dimensions of the inner metal portion of the bushing may include a length of the inner metal portion along the first centerline axis that extends beyond a corresponding end of the elastic portion.

A suspension assembly of a vehicle of an example embodiment may be provided. The suspension assembly may include a control arm to operably couple a wheel end assembly to a chassis of the vehicle, and a bushing to operably couple the control arm to the chassis. The bushing may further include a first end having a first coupling interface configured to operably couple to a first coupling point or a second coupling point of a chassis of the vehicle, a second end having a second coupling interface configured to operably couple to the second coupling point or the first coupling point of the chassis, an inner metal portion disposed along a first centerline axis of the bushing, an outer metal portion disposed radially outward from the inner metal portion, and an elastic portion disposed between the inner metal portion and the outer metal portion. A hardpoint may be defined between the first end and the second end along the inner metal portion at a first hardpoint location responsive to the first coupling interface operably coupling to the first coupling point and the second coupling interface operably coupling to the second coupling point, and a second hardpoint location responsive to the first coupling interface operably coupling to the second coupling point and the second coupling interface operably coupling to the first coupling point. The second hardpoint location may be shifted along a common axis relative to the first hardpoint location.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to difficulties are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A bushing of a coupling assembly, the bushing comprising:
a first end having a first coupling interface configured to operably couple to a first coupling point or a second coupling point;
a second end having a second coupling interface configured to operably couple to the second coupling point or the first coupling point;
an inner metal portion disposed along a first centerline axis of the bushing;
an outer metal portion disposed radially outward from the inner metal portion; and
an elastic portion disposed between the inner metal portion and the outer metal portion,
wherein a hardpoint is defined between the first end and the second end along the inner metal portion at a first hardpoint location responsive to the first coupling interface operably coupling to the first coupling point and the second coupling interface operably coupling to the second coupling point and a second hardpoint location responsive to the first coupling interface operably coupling to the second coupling point and the second coupling interface operably coupling to the first coupling point, and
wherein the second hardpoint location is shifted along a common axis relative to the first hardpoint location.

2. The bushing of claim 1, wherein the bushing is a through-bushing, a bar pin bushing, or an inclined bushing.

3. The bushing of claim 1, wherein the vehicle is at a first ride height responsive to the hardpoint being disposed at the first hardpoint location, and
wherein the vehicle is at a second ride height responsive to the hardpoint being disposed at the second hardpoint location.

4. The bushing of claim 1, wherein the first coupling point and the second coupling point are disposed at different locations along an X-axis, a Y-axis, and a Z-axis.

5. The bushing of claim 1, wherein the bushing is in a first state responsive to first coupling interface operably coupling to the first coupling point and the second coupling interface operably coupling to the second coupling point,
wherein the bushing is in a second state responsive to the first coupling interface operably coupling to the second coupling point and the second coupling interface operably coupling to the first coupling point, and
wherein the bushing is rotated an amount of degrees between the first state and the second state.

6. The bushing of claim 1, wherein a difference between the first hardpoint location and the second hardpoint location along the common axis between the first hardpoint location and the second hardpoint location defines an offset, and
wherein the offset is variable based on bushing parameters.

7. The bushing of claim 6, wherein the bushing parameters include a jog of the bushing,
wherein the jog of the bushing is a distance between a second centerline axis of the bushing and a third centerline axis of a fastener configured to operably couple the bushing to the suspension assembly via the first coupling point or the second coupling point.

8. The bushing of claim 6, wherein the bushing parameters include a thickness of the bushing at the first coupling interface and the second coupling interface.

9. The bushing of claim 6, wherein the bushing parameters include dimensions of the inner metal portion of the bushing.

10. The bushing of claim 9, wherein the dimensions of the inner metal portion of the bushing include a length of the inner metal portion along the first centerline axis that extends beyond a corresponding end of the elastic portion.

11. A suspension assembly of a vehicle, the suspension assembly comprising:
a control arm to operably couple a wheel end assembly to a chassis of the vehicle; and
a bushing configured to operably couple the control arm to the chassis, the bushing further comprising:
a first end having a first coupling interface configured to operably couple to a first coupling point or a second coupling point of the chassis of the vehicle;
a second end having a second coupling interface configured to operably couple to the second coupling point or the first coupling point of the chassis;
an inner metal portion disposed along a first centerline axis of the bushing;
an outer metal portion disposed radially outward from the inner metal portion; and
an elastic portion disposed between the inner metal portion and the outer metal portion,
wherein a hardpoint is defined between the first end and the second end along the inner metal portion at a first hardpoint location responsive to the first coupling interface operably coupling to the first coupling point and the second coupling interface operably coupling to the second coupling point and a second hardpoint location responsive to the first coupling interface operably coupling to the second coupling point and the second coupling interface operably coupling to the first coupling point, and
wherein the second hardpoint location is shifted along a common axis relative to the first hardpoint location.

12. The suspension assembly of claim 11, wherein the bushing is a through-bushing, a bar pin bushing, or an inclined bushing.

13. The suspension assembly of claim 11, wherein the vehicle is at a first ride height responsive to the hardpoint being disposed at the first hardpoint location, and
wherein the vehicle is at a second ride height responsive to the hardpoint being disposed at the second hardpoint location.

14. The suspension assembly of claim 11, wherein the first coupling point and the second coupling point are disposed at different locations along an X axis, a Y axis, and a Z axis.

15. The suspension assembly of claim 11, wherein the bushing is in a first state responsive to first coupling interface operably coupling to the first coupling point and the second coupling interface operably coupling to the second coupling point,
wherein the bushing is in a second state responsive to the first coupling interface operably coupling to the second coupling point and the second coupling interface operably coupling to the first coupling point, and
wherein the bushing is rotated an amount of degrees between the first state and the second state.

16. The suspension assembly of claim 11, wherein a difference between the first hardpoint location and the second hardpoint location along the common axis between the first hardpoint location and the second hardpoint location defines an offset, and
wherein the offset is variable based on bushing parameters.

17. The suspension assembly of claim 16, wherein the bushing parameters include a jog of the bushing,
wherein the jog of the bushing is a distance between a second centerline axis of the bushing and a third centerline axis of a fastener configured to operably couple the bushing to the suspension assembly via the first coupling point or the second coupling point.

18. The suspension assembly of claim 16, wherein the bushing parameters include a thickness of the bushing at the first coupling interface and the second coupling interface.

19. The suspension assembly of claim 16, wherein the bushing parameters include dimensions of the inner metal portion of the bushing.

20. The suspension assembly of claim 19, wherein the dimensions of the inner metal portion of the bushing include a length of the inner metal portion along the first centerline axis that extends beyond a corresponding end of the elastic portion.
